(19) United States
(12) Patent Application Publication
(10) Pub. No.: US 2024/0157489 A1
(43) Pub. Date: May 16, 2024

(54) POSITIONER

(71) Applicant: FANUC CORPORATION, Minamitsuru-gun, Yamanashi (JP)

(72) Inventors: Kaname KIKUCHI, Yamanashi (JP); Tomoyuki MOTOKADO, Yamanashi (JP); Akihiro OIKAWA, Yamanashi (JP); Toshihiko INOUE, Yamanashi (JP)

(73) Assignee: FANUC CORPORATION, Minamitsuru-gun, Yamanashi (JP)

(21) Appl. No.: 18/550,999

(22) PCT Filed: Jun. 28, 2021
(86) PCT No.: PCT/JP2021/024329

§ 371 Date: Sep. 18, 2023

(51) Int. Cl. B23K 37/047; B23Q 1/54

(52) U.S. Cl. CPC B23K 37/047; B23Q 1/54

(57) ABSTRACT

This positioner comprises: a first member; a rotating table supported to rotate about an axis relative to the first member; a motor that is parallel to and offset from the axis and drives the rotating table; a reducer disposed between the first member and the rotating table, reducing the rotation of the motor and transmitting the reduced rotation to the rotating table; and a power cable for supplying power to the rotating table. The first member and the reducer are provided with a hollow section passing therethrough. A current collector brush is attachable to and detachable from one end of the power cable. The power cable extends, from the first member in a direction away from the rotating table. After being bent into a U-shape, the power cable passes through the hollow section along the axis, and one end of the power cable is detachably secured to the rotating table.

### RELATED APPLICATION DATA

This application is a national phase of International Application No. PCT/JP2021/024329 filed Jun. 28, 2021, which is hereby incorporated herein by reference in its entirety.

### TECHNICAL FIELD

The present disclosure relates to a positioner.

### BACKGROUND ART

There is a known one-axis positioner including a base that is installed on a horizontal installation face, and a rotating table that is supported so as to be rotatable about a horizontal rotation axis relative to the base (for example, see Patent Literature 1). In this positioner, a motor for rotationally driving the rotating table is disposed so as to be parallel to and offset from the rotation axis of the rotating table. In addition, a reducer that reduces the rotation of the motor and transmits the reduced rotation to the rotating table has a hollow section in a region including the rotation axis.

A cylindrical conductive shaft is disposed in the hollow section so as to pass therethrough in a direction along the rotation axis and one end thereof is secured to the rotating table, and a current collector brush is in contact with the outer circumferential surface of the shaft at the other end thereof. An external cable, one end of which is connected to a negative electrode of an external welding power supply, is connected to the current collector brush at the other end thereof. In this case, even if the rotating table is rotationally driven infinitely, an electrical connection between the welding power supply and the rotating table is maintained by means of the contact between the outer circumferential surface of the shaft and the current collector brush.

### CITATION LIST

### Patent Literature

{PTL 1} Japanese Unexamined Patent Application, Publication No. 2021-30265

### SUMMARY OF INVENTION

An aspect of the present disclosure is a positioner including: a first member; a rotating table supported so as to rotate about a prescribed axis relative to the first member; a motor that is disposed so as to be parallel to and offset from the axis and that rotationally drives the rotating table; a reducer that is disposed between the first member and the rotating table, the reducer reducing a rotation of the motor and transmitting the reduced rotation to the rotating table; and a power supply cable for supplying a power supply to the rotating table, wherein the first member and the reducer are provided with a hollow section passing therethrough in a direction following the axis within regions that include the axis, a brush attachment part for detachably securing a current collector brush that can be attached to and detached from one end of the power supply cable is provided, radially outside the hollow section, on a surface of the first member on a side opposite from the rotating table, and the power supply cable extends, from a vicinity of the surface of the first member that is away from the axis, in a direction away from the rotating table, and after being bent into a U-shape, the power supply cable passes through the hollow section along the axis, and one end of the power supply cable is detachably secured to the rotating table.

### BRIEF DESCRIPTION OF DRAWINGS

FIG. 1 is a perspective view showing a positioner according to a first embodiment of the present disclosure.

FIG. 2 is a longitudinal sectional view of the positioner in FIG. 1.

FIG. 3 is a diagram showing a first member of the positioner in FIG. 1, as viewed from a back side opposite from a rotating table.

FIG. 4 is a diagram showing a state in which a shaft is disposed in a second hollow section of the first member in FIG. 3, and a current collector brush is attached to a back-side surface of the first member.

FIG. 5 is a longitudinal sectional view of the positioner, showing the state in FIG. 4.

FIG. 6 is a longitudinal sectional view showing a positioner according to a second embodiment of the present disclosure.

### DESCRIPTION OF EMBODIMENT

A positioner 1 according to a first embodiment of the present disclosure will be described below with reference to the drawings.

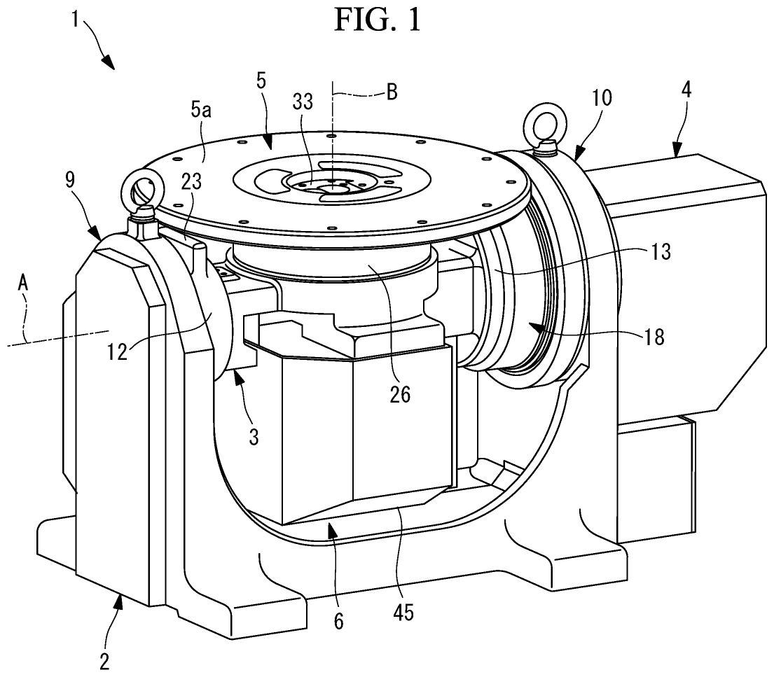

As shown in FIG. 1, the positioner 1 according to this embodiment includes: a base 2 that is installed on a horizontal installation face such as a floor; a first member 3 that is supported so as to be rotatable about a horizontal first axis A relative to the base 2; and a first drive mechanism 4 that rotationally drives the first member 3.

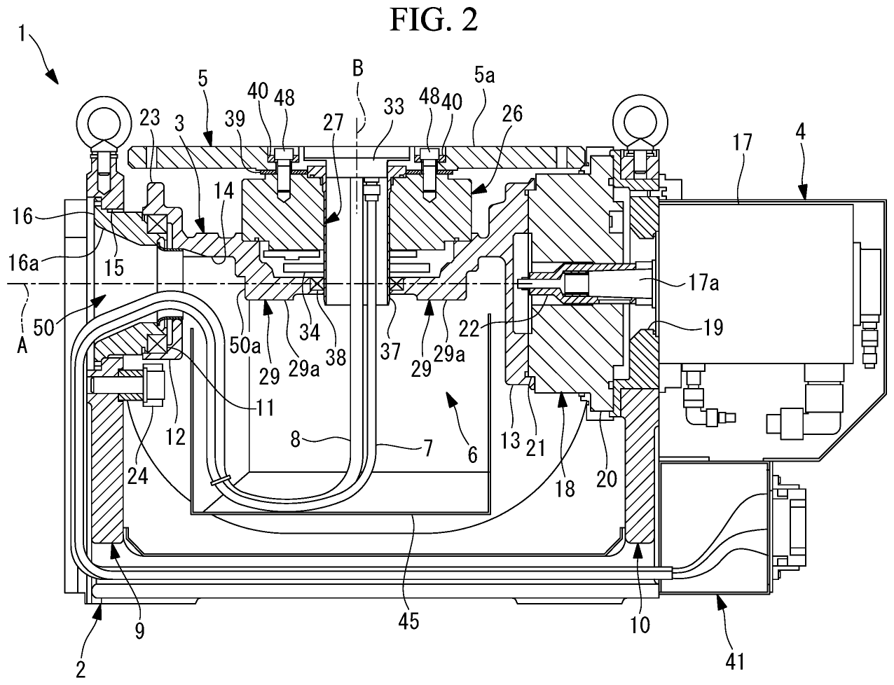

In addition, the positioner 1 includes a rotating table 5 that is supported so as to be rotatable about a second axis (prescribed axis) B, which is orthogonal to the first axis A, relative to the first member 3, and a second drive mechanism 6 that rotationally drives the rotating table 5. Furthermore, as shown in FIG. 2, the positioner 1 is provided with a power supply cable (wire body) 7 for connecting the rotating table 5 to a negative electrode for welding, and a pipe (wire body) 8 for supplying a fluid, such as pressurized air.

The base 2 includes a flat plate-like first support part 9 and second support part 10 that are arranged so as to be parallel to each other with a space therebetween in the first axis A direction. The first member 3 is bridged between the first support part 9 and the second support part 10 like a double-supported beam. The first member 3 includes a first shaft part (shaft part) 12 that is supported by the first support part 9 so as to be rotatable about the first axis A by means of a bearing 11, and a second shaft part 13 that is supported by the second support part 10 so as to be rotatable about the first axis A by means of a first reducer 18, which will be described later.

The first shaft part 12 is provided with a first hollow section 14 extending from an end surface along the first axis A. The first support part 9 is provided with a through-hole 15 penetrating in the first axis A direction. A cylindrical sleeve 16 having an inner hole 16a is fitted into the through-hole 15, and the sleeve 16 is secured to the first support part 9. In addition, the sleeve 16 is inserted into the first hollow section 14 from the end surface side of the first shaft part 12, and supports the first shaft part 12 so as to be rotatable about the first axis A by means of the bearing 11 fitted between an outer circumferential surface of the sleeve 16 and an inner circumferential surface of the first hollow section 14.

The first hollow section 14 provided in the first shaft part 12 extends in a direction intersecting the first axis A at a location farther on the second support part 10 side than a portion supported by the bearing 11, and opens to a surface side (hereinafter also referred to as “back side”) of the first member 3 opposite from the rotating table 5. Thus, a hollow path 50 is configured, from outside the first support part 9 in the first axis A direction, to pass through the inner hole 16a of the sleeve 16 and the first hollow section 14, and to penetrate the back side of the first member 3 between the first support part 9 and the second support part 10.

The first drive mechanism 4 includes a first motor 17 that is secured to the second support part 10 of the base 2, and the first reducer 18 that reduces the rotation of a motor shaft 17a of the first motor 17 and transmits the reduced rotation to the first member 3. The first motor 17 is secured to an outer surface of the second support part 10 such that the motor shaft 17a penetrates from outside the second support part 10 into a through-hole 19 provided in the second support part 10. The central axis of the motor shaft 17a coincides with the first axis A.

The first reducer 18 includes a fixed member 20 that is secured to the inner surface side of the second support part 10, and an output shaft member 21 that is rotated about the first axis A relative to the fixed member 20. A plurality of gears (not shown) including a gear that meshes with a gear 22 secured to the motor shaft 17a are accommodated in the interior of the fixed member 20 and the output shaft member 21. The output shaft member 21 is secured to an end surface of the second shaft part 13 of the first member 3.

In FIG. 2, reference sign 23 indicates a projection provided in the first member 3, and reference sign 24 indicates a stopper that is secured to the base 2 and against which the projection 23 is abutted. By providing the base 2 with the stopper 24 against which the projection 23 provided in the first member 3 is abutted when the first member 3 rotates about the first axis A, the rotation angle range of the first member 3 is limited to a magnitude smaller than one rotation.

The rotating table 5 includes a placement surface 5a on which a workpiece or the like is placed, is made of a conductive material, and is formed in a disk shape. The rotating table 5 is disposed at a position where the central axis thereof is aligned with the second axis B, and is supported by the first member 3 so as to be rotatable about the second axis B by means of a second reducer, which will be described later.

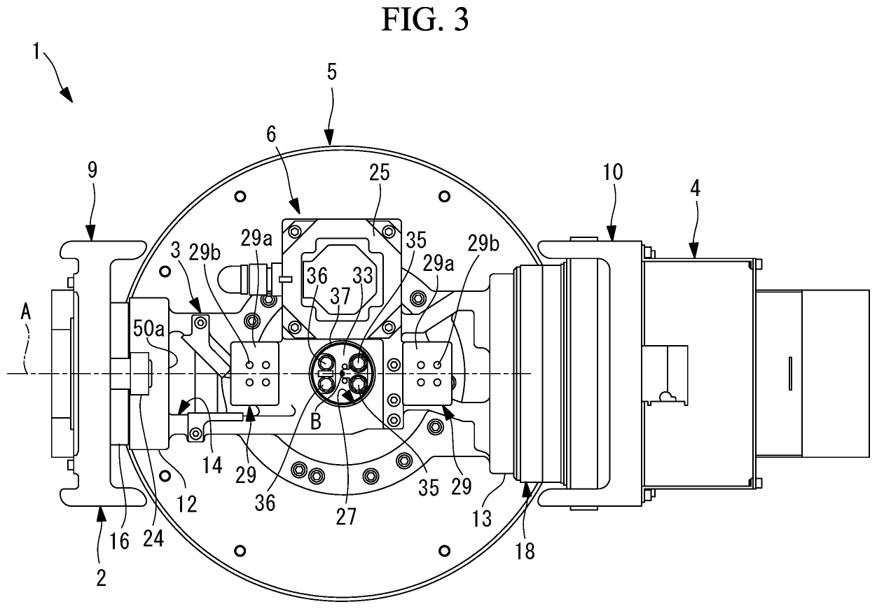

As shown in FIGS. 2 and 3, the second drive mechanism 6 includes a second motor (motor) 25 that is secured to the first member 3 so as to be parallel to and offset from the second axis B, and a second reducer (reducer) 26 that reduces the rotation of a motor shaft (not shown) of the second motor 25 and transmits the reduced rotation to the rotating table 5. The second motor 25 is secured to a surface on an opening 50a side (back side) of the hollow path 50 in the first member 3. The second reducer 26 is disposed between the first member 3 and the rotating table 5. The rotation of the motor shaft of the second motor 25 offset from the second axis B is reduced once by a gear 34, and subsequently, is further reduced at the second reducer 26 and is transmitted to the rotating table 5. The second drive mechanism 6 is not provided with such a stopper 24, as in the first drive mechanism 4.

The rotating table 5, the second reducer 26, and the first member 3 are provided with a second hollow section (hollow section) 27 penetrating along the second axis B in regions including the second axis B. One end of the second hollow section 27 in the second axis B direction opens to the placement surface 5a side of the rotating table 5, and the other end thereof opens to the back-side surface of the first member 3 where the opening 50a of the hollow path 50 is located.

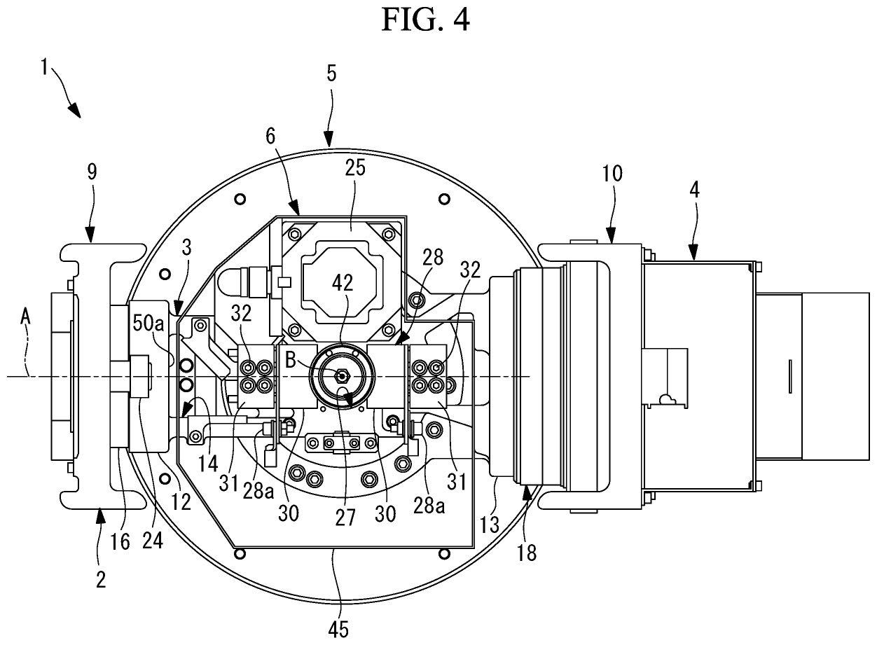

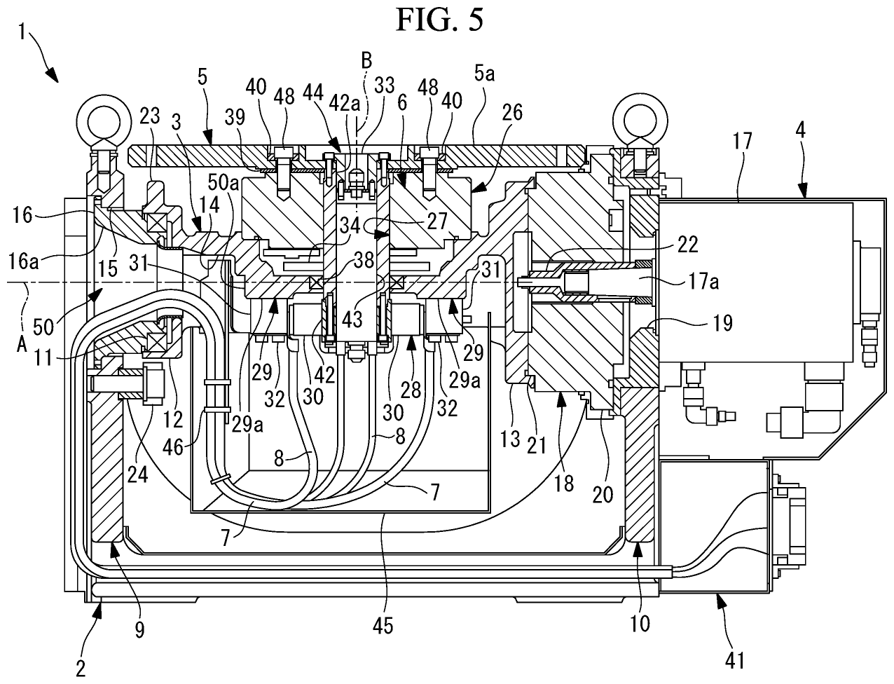

As shown in FIGS. 2 and 3, a brush attachment part 29 to which a current collector brush 28, which will be described later, can be detachably attached is provided on the back-side surface (the surface on the side opposite from the rotating table 5) of the first member 3, which is located in the periphery of the back-side opening of the second hollow section 27. As shown in FIGS. 4 and 5, the current collector brush 28 includes, for example, a brush part 30 made of carbon and a pressing part 31 that includes a spring (not shown) for pressing the brush part 30 radially inward from radially outside the second hollow section 27. The current collector brush 28 is provided with a terminal 28a to which the power supply cable 7 is detachably connected.

The brush attachment part 29 includes a bearing surface 29a with which the pressing part 31 is brought into close contact in a direction along the second axis B, and one or more screw holes 29b provided in the bearing surface 29a and for securing the pressing part 31 to the first member 3 by means of screws 32. The brush attachment part 29 is provided at two locations spaced apart in a circumferential direction around the second axis B. In an example shown in FIG. 3, the brush attachment parts 29 are arranged at locations separated by 180° in the circumferential direction so as to radially sandwich the second hollow section 27 therebetween.

At the opening of the second hollow section 27 in the rotating table 5, as shown in FIG. 2, an adapter 33 made of a conductive material is secured, at such a position that the adapter 33 closes the opening, so as to be detachable from the placement surface 5a side of the rotating table 5.

The adapter 33 is provided with terminals 35 and through-holes 36 to which the power supply cable 7 and the pipe 8 can be connected, as will be described later.

In the figures, reference sign 37 indicates a cylindrical sleeve member that is arranged so as to pass through the second hollow section 27 in the second axis B direction in order to seal, by means of an oil seal 38 secured to the first member 3, the interior of the second reducer 26 and a lubrication space in which the gear 34 is disposed. In addition, reference sign 39 indicates an insulating plate that electrically insulates the second reducer 26 and the rotating table 5, and reference sign 40 indicates insulating washers that electrically insulate bolts 48 and the rotating table 5. The insulating plate 39 and the insulating washers 40 are made of an electrically insulating material, for example, an insulating resin.

As shown in FIG. 2, the power supply cable 7 and the pipe 8 are each secured, at one end thereof, to a power distribution box 41 installed on the side of the second support part 10. When an externally located power supply device (not shown) and fluid supply source (not shown) are connected to the power supply cable 7 and the pipe 8 in the power distribution box 41, it becomes possible to connect the rotating table 5 to the negative electrode and to supply a fluid to the rotating table 5.

In addition, each of motor cables (not shown) connected to the first motor 17 and the second motor 25 also has one end secured to the power distribution box 41. Cables (not shown) extending from an externally located controller (not shown) are connected to the ends of the motor cables in the power distribution box 41.

The other end of the motor cable for the first motor 17 is connected to the first motor 17 close to the power distribution box 41. The power supply cable 7 and the pipe 8 are guided, together with the motor cable for the second motor 25, which is to be connected to the second motor 25, from the power distribution box 41 to, for example, the first support part 9 side through a lower portion of the base 2, and are subsequently introduced into the hollow path 50 from outside the first support part 9.

The wire bodies, such as the power supply cable 7, that have been introduced into the hollow path 50 extend along the first axis A, in the vicinity of the first axis A, in the hollow path 50, and are subsequently led out of the back-side opening 50a of the first member 3 to the outside of the hollow path 50.

The motor cable for the second motor 25, which has been led out of the back-side opening 50a of the first member 3, is connected to the second motor 25 secured to the first member 3.

The wire bodies, such as the power supply cable 7, that have been led out of the back-side opening 50a of the first member 3 extend in a direction away from the rotating table 5 from the vicinity of the surface of the first member 3, which is away from the second axis B, and are subsequently bent by approximately 180° into a U-shape. The bent wire bodies, such as the power supply cable 7, extend along the second axis B, are introduced into the second hollow section 27 from the back-side opening of the second hollow section 27, and the other ends thereof are detachably secured to the adapter 33.

The wire bodies, such as the power supply cable 7, are arranged such that the portions thereof bent by 180° in a direction along the second axis B are located farther on the rotating table 5 side than a head-side end portion of the second motor 25. In other words, the wire bodies, such as the power supply cable 7, are folded by 180° at a position where the wire bodies do not exceed the head-side end portion of the second motor 25.

The power supply cable 7 and the pipe 8 passing through the second hollow section 27 extend substantially straight along the second axis B, in the vicinity of the second axis B. From the position where the power supply cable 7 and the pipe 8 are led out of the opening 50a of the first member 3 to the position where the power supply cable 7 and the pipe 8 are connected to the adapter 33 of the rotating table 5, the power supply cable 7 and the pipe 8 that are bent in the U-shape are in a free state allowing displacement without interference with surrounding members.

The operation of the thus-configured positioner 1 according to this embodiment will be described below.

With the positioner 1 according to this embodiment, the power supply cable 7 and the pipe 8 are connected to the adapter 33 secured to the rotating table 5; thus, it is possible to connect a workpiece mounted on the placement surface 5a of the rotating table 5 to the negative electrode, and to supply a fluid.

In this case, by actuating the first drive mechanism 4 to rotate the first member 3 about the first axis A relative to the base 2, it is possible to change the tilt angle of the workpiece about the first axis A. In addition, by actuating the second drive mechanism 6 to rotate the rotating table 5 about the second axis B relative to the first member 3, it is possible to change the angle of the workpiece about the second axis B.

When the first member 3 rotates about the first axis A relative to the base 2, a torsional force acts on the power supply cable 7 and the pipe 8 in portions disposed in the hollow path 50. Because the power supply cable 7 and the pipe 8 in the hollow path 50 extend along the first axis A, in the vicinity of the first axis A, it is possible to absorb the torsional force by torsionally deforming the portions.

In particular, the rotation of the first member 3 about the first axis A relative to the base 2 changes the tilt angle of the workpiece relative to a horizontal plane, and because the rotation angle range is limited by the projection 23 and the stopper 24, the power supply cable 7 and the pipe 8 are not subjected to a large torsional force.

Meanwhile, when the rotating table 5 is rotated about the second axis B relative to the first member 3, a twisting force acts on the power supply cable 7 and the pipe 8 that are secured to the rotating table 5 by means of the adapter 33. In a case in which the rotation angle range of the rotating table 5 about the second axis B is relatively large, a relatively large torsional force acts on the power supply cable 7 and the pipe 8.

With this embodiment, the wire bodies, such as the power supply cable 7, between the opening 50a of the hollow path 50 in the first member 3 and the adapter 33 are in a free state over a relatively long range as a result of being folded by 180° into a U-shape. Therefore, even when the rotating table 5 rotates about the second axis B and the wire bodies are subjected to the torsional force about the second axis B, it is possible to effectively absorb the torsional force by applying torsional deformation or bending deformation to the free state portions of the wire bodies, such as the power supply cable 7, between the opening 50a in the first member 3 and the adapter 33. By doing so, it is possible to reduce the load on the wire bodies, such as the power supply cable 7.

In other words, for uses in which the rotating table 5 rotates about the second axis B by a prescribed angle, for example, ±180° within a relatively large rotation angle range, the wire bodies, such as the power supply cable 7, may be utilized as movable cables or the like with reduced load thereon. In addition, a current collector brush and a shaft for allowing infinite rotation are not necessary in this case, and there is an advantage in that it is possible to reduce costs and facilitate maintenance as a result of not being equipped with these components.

Meanwhile, in cases in which the positioner 1 is used for uses in which it is necessary to infinitely rotate the rotating table 5 about the second axis B, or for uses in which it is necessary to rotate the rotating table 5, for example, in a relatively large rotation angle range exceeding 360°, the positioner 1 is set as follows.

First, the adapter 33 is removed from the rotating table 5, and the power supply cable 7 and the pipe 8 connected to the adapter 33 are removed and led out of the second hollow section 27. In addition, the sleeve member 37 secured with respect to the rotating table 5 is removed.

Next, as shown in FIG. 5, another adapter 44, which is equipped with a cylindrical shaft 42 made of a conductive material and a rotary joint 43 disposed in an inner hole 42a of the shaft 42, is attached to the rotating table 5. When the adapter 44 is attached to the rotating table 5, the shaft 42 and the rotary joint 43 are arranged so as to pass through the second hollow section 27 coaxially with the second axis B. At this time, the distal end of the shaft 42 is disposed at a position where the distal end protrudes to the outside from the back-side opening of the second hollow section 27. The outer diameter of the shaft 42 is the same as the outer diameter of the sleeve member 37, and thus, sealing of the lubrication space by means of the oil seal 38 is maintained.

In addition, as shown in FIGS. 4 and 5, the current collector brush 28 is attached to the brush attachment part 29 provided in the first member 3.

The current collector brush 28 is attached to the first member 3 by securing the pressing part 31 to the brush attachment part 29. The brush part 30 is pressed from radially outside, by means of the spring of the pressing part 31, against an outer circumferential surface of the shaft 42 exposed to the back side of the first member 3.

Lastly, the power supply cable 7 that has been removed from the adapter 33 is connected to the current collector brush 28 by means of the terminal 28a, and the pipe 8 is connected to the rotary joint 43.

By doing so, when the rotating table 5 is rotated about the second axis B, the shaft 42 is rotated together with the rotating table 5, and the contact between the outer circumferential surface of the shaft 42 and the brush part 30 is maintained. Therefore, by employing the current collector brush 28, even when the rotating table 5 infinitely rotates, it is possible to continuously connect the rotating table 5 to the negative electrode while the power supply cable 7 is kept in a secured state.

With this embodiment, the brush attachment part 29 is provided at two locations radially sandwiching the second hollow section 27; thus, it is possible to press the brush parts 30 against the outer circumferential surface of the shaft 42 in opposing directions from both sides sandwiching the shaft 42. With this configuration, it is possible to cancel out the pressing forces of the brush parts 30 acting on the shaft 42, thereby preventing a biased force from acting on the shaft 42.

In addition, by connecting the pipe 8 to the rotary joint 43, even when the rotating table 5 rotates about the second axis B, it is possible to maintain the flow path of a fluid in a connected state. Therefore, it is possible to continuously supply the fluid to the rotating table 5 regardless of the rotation angle of the rotating table 5.

In this case, because the wire bodies, such as the power supply cable 7, that were directly connected to the adapter 33 had an extra length sufficient to be movable by being bent into a U-shape, the wire bodies have a sufficient length also in the case of being connected to the current collector brush 28 or the rotary joint 43.

In addition, although the power supply cable 7 and the pipe 8 are relatively thick and rigid, the wire bodies having a sufficient length can be easily bent, as described above, and thus can be easily routed to be connected to the current collector brush 28 and the rotary joint 43.

Therefore, even when the current collector brush 28 and the rotary joint 43 need to be equipped due to a change in use, the current collector brush 28 and the rotary joint 43 can be equipped in a simple manner without replacing the wire bodies, such as the power supply cable 7. In other words, there is an advantage in that it is possible to easily switch from a configuration not equipped with the current collector brush 28, for example, in a case in which the required rotation angle range of the rotating table 5 is small, to a configuration equipped with the current collector brush 28, for example, in a case in which the required rotation angle range of the rotating table 5 is large, or vice versa.

The power supply cable 7 connected to the current collector brush 28 and the pipe 8 connected to the rotary joint 43 are maintained in a stationary state regardless of the rotation of the rotating table 5. In this case, the power supply cable 7 etc. that have been led out of the opening 50a of the hollow path 50 of the first member 3 are preferably secured to the first member 3 by means of a bundling band 46 or a clamp member or the like to prevent movement thereof.

Next, a positioner 51 according to a second embodiment of the present disclosure will be described below with reference to the drawings. In the description of this embodiment, parts having the same configuration as those in the positioner 1 according to the first embodiment will be assigned the same reference signs, and descriptions thereof will be omitted.

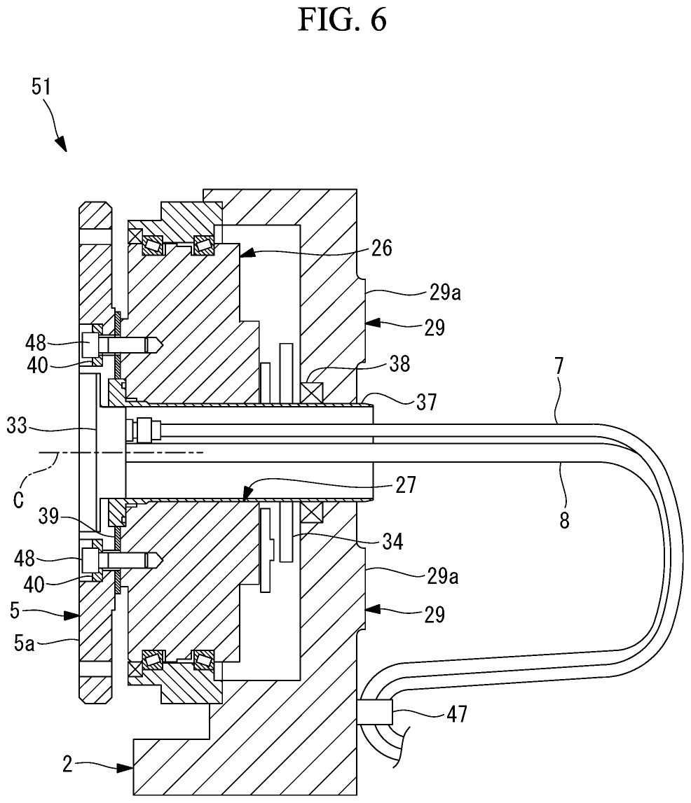

In the first embodiment, a two-axis positioner in which the rotating table 5 is supported so as to be rotatable about the first axis A and the second axis B has been illustrated as an example. Alternatively, as shown in FIG. 6, the positioner 51 according to this embodiment is a one-axis positioner in which the rotating table 5 is rotated only about a central axis C thereof relative to the base 2. In this case, the base 2 corresponds to the first member 3.

In the positioner 51 according to this embodiment, the wire bodies, such as the power supply cable 7, extending from the power distribution box 41 are secured, at an intermediate position in a longitudinal direction thereof, by means of a clamp member 47 at a location away from the central axis C of the rotating table 5 and close to the back side of the rotating table 5. The wire bodies, such as the power supply cable 7, are bent in a direction away from the rotating table 5 from the location where the wire bodies are secured by means of the clamp member 47, are subsequently bent by 180° into a U-shape, and are introduced into the second hollow section (hollow section) 27 along the central axis C of the rotating table 5. The wire bodies, such as the power supply cable 7, introduced into the second hollow section 27 are directly connected to the adapter 33 of the rotating table 5.

Also in the positioner 51 according to this embodiment, it is possible to easily switch the configuration in the case in which the rotation angle range of the rotating table 5 is large, by attaching the shaft 42 and the rotary joint 43 to the rotating table 5 and attaching the current collector brush 28 to the brush attachment part 29. In this case, because the wire bodies, such as the power supply cable 7, had an extra length sufficient to be movable, the wire bodies have a sufficient length also in the case of being connected to the current collector brush 28 or the rotary joint 43. In addition, although the wire bodies, such as the power supply cable 7, are relatively thick and rigid, there is an advantage in that the long wire bodies can be relatively easily bent, and thus can be easily routed to be connected to the current collector brush 28 and the rotary joint 43.

Note that, in the positioners 1, 51 according to the respective embodiments described above, the brush attachment part 29 is provided at two locations spaced apart in the circumferential direction, radially outside the second hollow section 27 of the first member 3; alternatively, however, the brush attachment part 29 may be provided at one location or three or more locations. By providing a plurality of the brush attachment parts 29, even if the contact between one brush part 30 and the shaft 42 fails, there is redundancy in that the contact between another brush part 30 and the shaft 42 can maintain the electrical connection.

In addition, also in the case in which three or more current collector brushes 28 are attached, the brush attachment parts 29 are preferably arranged at equal intervals in the circumferential direction around the central axis of the rotating table 5. With this configuration, it is possible to cancel out the pressing forces applied to the shaft 42 from the brush parts 30 to eliminate the bias.

In addition, instead of arranging the brush attachment parts 29 at equal intervals in the circumferential direction around the central axis of the rotating table 5, in a case in which the pressing force bias is acceptable, the brush attachment part 29 may be arranged at one location or at a plurality of locations at unequal intervals in the circumferential direction. In addition, instead of arranging the plurality of current collector brushes 28 at locations spaced apart in the circumferential direction, the plurality of current collector brushes 28 may be arranged, at the same location in the circumferential direction, side by side in a direction along the central axis of the rotating table 5. With this configuration, it is possible to reduce the installation space for the current collector brushes 28 around the central axis of the rotating table 5, while maintaining the redundancy of the current collector brushes 28.

In addition, the brush attachment part 29 includes the bearing surface 29a with which the pressing part 31 is brought into close contact in a direction along the central axis A, C of the rotating table 5. In this case, the bearing surface 29a is formed along a plane orthogonal to the central axis A, C. Alternatively, the bearing surface 29a may be formed along a plane parallel to the central axis A, C of the rotating table 5.

In addition, although a case in which the power supply cable 7 and the pipe 8 are connected to the adapter 33 secured to the rotating table 5 has been described in this embodiment, a signal cable may be additionally connected. For uses in which the rotating table 5 is infinitely rotated, the signal cable can be maintained in a connected state by means of the rotary joint 43.

In addition, in this embodiment, as shown in FIGS. 4 and 5, a dust cover 45 may be provided so as to cover the second motor 25 secured to the back-side surface of the first member 3, the brush attachment part 29, the opening 50a of the first hollow section 14, and the opening of the second hollow section 27. With this configuration, it is possible to protect the power supply cable 7 led out of the opening 50a of the first hollow section 14, the motor cable for the second motor 25, the pipe 8, the opening 50a of the first hollow section 14, and the opening of the second hollow section 27 so as not to be exposed to the outside.

In addition, in the case in which the current collector brush 28 is attached to the brush attachment part 29, the current collector brush 28 and the shaft 42 can also be disposed inside the dust cover 45. With this configuration, it is possible to prevent dust from the outside from adhering between the brush part 30 and the shaft 42, and also to prevent abrasion powder of the brush part 30 or the shaft 42 from scattering to the outside.

In addition, the bent portions of the wire bodies, such as the power supply cable 7, are folded at a position where the wire bodies do not exceed the head-side end portion of the second motor 25; therefore, it is possible to minimize the height of the dust cover 45 covering the back side of the first member 3, including the second motor 25. With this configuration, it is possible to reduce the size of the positioner 1, while preventing interference between the dust cover 45 and the base 2 during the rotation of the first member 3 about the first axis A.

### REFERENCE SIGNS LIST

1, 51 positioner
2 base (first member)
3 first member
5 rotating table
7 power supply cable
12 first shaft part (shaft part)
25 second motor (motor)
26 second reducer (reducer)
27 second hollow section (hollow section)
28 current collector brush
29 brush attachment part
50 hollow path
A first axis
B second axis (prescribed axis)
C central axis (prescribed axis)

1. A positioner comprising:
a first member;
a rotating table supported so as to rotate about a prescribed axis relative to the first member;
a motor that is disposed so as to be parallel to and offset from the axis and that rotationally drives the rotating table;
a reducer that is disposed between the first member and the rotating table, the reducer reducing a rotation of the motor and transmitting the reduced rotation to the rotating table; and
a power supply cable for supplying a power supply to the rotating table,
wherein the first member and the reducer are provided with a hollow section passing therethrough in a direction following the axis within regions that include the axis,
a brush attachment part for detachably securing a current collector brush that can be attached to and detached from one end of the power supply cable is provided, radially outside the hollow section, on a surface of the first member on a side opposite from the rotating table, and
the power supply cable extends, from a vicinity of the surface of the first member that is away from the axis, in a direction away from the rotating table, and after being bent into a U-shape, the power supply cable passes through the hollow section along the axis, and one end of the power supply cable is detachably secured to the rotating table.

2. The positioner according to claim 1, further comprising a base that is installed on a horizontal installation face, wherein:
the first member includes a shaft part that is supported so as to be rotatable about a horizontal first axis orthogonal to the axis relative to the base, and also includes a hollow path that extends along the first axis from an end portion of the shaft part, in a region including the first axis, and that opens to the surface; and
the power supply cable passes through the hollow path and is connected to an external power supply device.
